(19) United States
(12) Patent Application Publication
(10) Pub. No.: US 2025/0336610 A1
(43) Pub. Date: Oct. 30, 2025

(54) MULTILAYER CERAMIC CAPACITOR

(71) Applicant: Murata Manufacturing Co., Ltd., Nagaokakyo-shi (JP)

(72) Inventor: Shoji FUKUI, Nagaokakyo-shi (JP)

(21) Appl. No.: 19/173,960

(22) Filed: Apr. 9, 2025

(30) Foreign Application Priority Data
Apr. 26, 2024 (JP) 2024-072788

(51) Int. Cl. H01G 4/30; H01G 4/012; H01G 4/232

(52) U.S. Cl. CPC H01G 4/30; H01G 4/012; H01G 4/2325

(57) ABSTRACT

A multilayer ceramic capacitor includes an element body portion and an external electrode on each of first and second end surfaces and connected to internal electrode layers. In a cross section along a stacking direction and a width direction at a central portion of the element body portion in a length direction, a maximum displacement amount in the width direction in the internal electrode layers is about 5 μm or less. Opposite edges of each of the internal electrode layers in the width direction include two straight portions extending linearly and spaced apart from each other and two curved portions connected to the two straight portions and curved with a curvature causing the two curved portions to approach each other with an increasing distance from the two straight portions. A maximum displacement amount at a connection end of the internal electrode layers is about 5 μm or less.

### CROSS REFERENCE TO RELATED APPLICATIONS

This nonprovisional application is based on Japanese Patent Application No. 2024-072788 filed on Apr. 26, 2024 with the Japan Patent Office, the entire contents of which are hereby incorporated by reference.

### BACKGROUND OF THE INVENTION

### 1. Field of the Invention

The present invention relates multilayer ceramic capacitors.

### 2. Description of the Related Art

Japanese Patent Laid-Open No. 2017-147429 is a prior art document that discloses a configuration of a multilayer ceramic capacitor. The multilayer ceramic capacitor disclosed in Japanese Patent Laid-Open No. 2017-147429 includes a stack portion of a substantially rectangular parallelepiped shape including a plurality of ceramic layers and a plurality of internal electrodes stacked alternately, side margin portions covering a pair of side surfaces of the stack portion in a width direction, and junctions disposed between the stack portion and the side margin portion.

Recent multilayer ceramic capacitors increasingly have smaller size and higher capacitance. In more detail, as the external sizes of the multilayer ceramic capacitors are becoming smaller, the ratio of the area occupied by the internal electrode layers to the external shape increases, and as a result, the side margin portions that sandwich the stacked plurality of internal electrode layers in the width direction may become thinner.

When the side margin portions become thinner in this manner, a moisture infiltration path becomes shorter that extends from the pair of side surfaces of the multilayer ceramic capacitor in the width direction to the internal electrode layer exposed on the end surface of the multilayer ceramic capacitor in the length direction through the end surface, and as a result, the moisture resistance of the multilayer ceramic capacitor may decrease.

### SUMMARY OF THE INVENTION

Therefore, example embodiments of the present invention provide multilayer ceramic capacitors each with an improved moisture resistance.

A multilayer ceramic capacitor according to an example embodiment of the present invention includes an element body portion and an external electrode. The element body portion includes a plurality of dielectric layers and a plurality of internal electrode layers stacked in a stacking direction, a first main surface and a second main surface opposite to each other in the stacking direction, a first side surface and a second side surface opposite to each other in a width direction orthogonal or substantially orthogonal to the stacking direction, and a first end surface and a second end surface opposite to each other in a length direction orthogonal or substantially orthogonal to the stacking direction and the width direction. The external electrode is provided on each of the first end surface and the second end surface and connected to the plurality of internal electrode layers. In a cross section along the stacking direction and the width direction at a central portion of the element body portion in the length direction, a maximum displacement amount in the width direction in the plurality of internal electrode layers is about 5 μm or less. Opposite edges of each of the plurality of internal electrode layers in the width direction include two straight portions and two curved portions. The two straight portions extend linearly in the length direction while being spaced apart from each other in the width direction. The two curved portions are respectively connected to the two straight portions. The two curved portions are curved at a curvature causing the two curved portions to approach each other in the width direction with an increasing distance from the two straight portions in the length direction. In the multilayer ceramic capacitor according to the present example embodiment, a connection end located at an end of each of the plurality of internal electrode layers in the length direction and connected to the external electrode is connected to the two curved portions, and in the first end surface and the second end surface, the maximum displacement amount in the width direction at the connection end in the plurality of internal electrode layers is about 5 μm or less.

In a multilayer ceramic capacitor according to an example embodiment of present invention, the element body portion may include a ridge portion, the ridge portion being a portion at which two adjacent surfaces of the first side surface, the second side surface, the first end surface, and the second end surface intersect each other. In this case, the curvature of each of the two curved portions may be smaller than a curvature of the ridge portion.

In a multilayer ceramic capacitor according to an example embodiment of the present invention, in the element body portion, a side margin portion located between the first side surface and the plurality of internal electrode layers and a side margin portion located between the second side surface and the plurality of internal electrode layers in the width direction each may include a plurality of layers stacked in the width direction.

In a multilayer ceramic capacitor according to an example embodiment of the present invention, the element body portion may include a ridge portion, the ridge portion being a portion at which two adjacent surfaces of the first side surface, the second side surface, the first end surface, and the second end surface intersect each other. In this case, an innermost layer located on an innermost side in the width direction among the plurality of layers of each side margin portion may be provided along the plurality of internal electrode layers. Also, in this case, a curvature of a surface located on an outer side of the innermost layer in the width direction may be greater than the curvature of each of the two curved portions and smaller than a curvature of the ridge portion.

In a multilayer ceramic capacitors according to an example embodiment of the present invention, Mg may be segregated at opposite edges of each of the plurality of internal electrode layers in the width direction.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view schematically showing an appearance of a multilayer ceramic capacitor according to an example embodiment of the present invention.

FIG. 2 is a schematic perspective view of an element body portion of a multilayer ceramic capacitor according to an example embodiment of the present invention.

FIG. 3 is an exploded perspective view for schematically illustrating a configuration of the element body portion shown in FIG. 2.

FIG. 4 is a schematic sectional view taken along the line IV-IV shown in FIG. 1.

FIG. 5 is a schematic sectional view taken along the line V-V shown in FIG. 1.

FIG. 6 is a schematic sectional view taken along the line VI-VI shown in FIG. 4.

FIG. 7 is an enlarged schematic sectional view of a connection end and its vicinity shown in FIG. 6.

FIG. 8 is a schematic sectional view taken along the line VIII-VIII shown in FIG. 4.

FIG. 9 is an enlarged schematic sectional view of the connection end and its vicinity shown in FIG. 8.

FIG. 10 is a schematic sectional view for illustrating a displacement in a width direction in facing portions of internal electrode layers in a multilayer ceramic capacitor according to an example embodiment of the present invention.

FIG. 11 is a schematic sectional view for illustrating a displacement in a width direction in lead portions of internal electrode layers in a multilayer ceramic capacitor according to an example embodiment of the present invention.

FIG. 12 is a flowchart showing a method of manufacturing a multilayer ceramic capacitor according to an example embodiment of the present invention.

FIG. 13 is a schematic sectional view of a multilayer ceramic capacitor according to Modification 1 of an example embodiment of the present invention.

FIG. 14 is an enlarged schematic sectional view of a connection end and its vicinity shown in FIG. 13.

FIG. 15 is a schematic sectional view of a multilayer ceramic capacitor according to Modification 2 of an example embodiment of the present invention.

FIG. 16 is another schematic sectional view of the multilayer ceramic capacitor according to Modification 2.

FIG. 17 is an enlarged schematic plan view for illustrating the positional relationship between a first internal electrode layer shown in FIG. 15 and a second internal electrode layer shown in FIG. 16.

### DETAILED DESCRIPTION OF THE EXAMPLE EMBODIMENTS

Example embodiments of the present invention will be described below in detail with reference to the drawings. In the following example embodiments, the same or common components are indicated by the same symbols in the figures, and the description thereof will not be repeated. In the figures, the length direction of an element body portion is indicated by L, the width direction of the element body portion is indicated by W, and the stacking direction of the element body portion is indicated by T. The element body portion will be described later in detail.

### EXAMPLE EMBODIMENTS

### A. Configuration of Multilayer Ceramic Capacitor

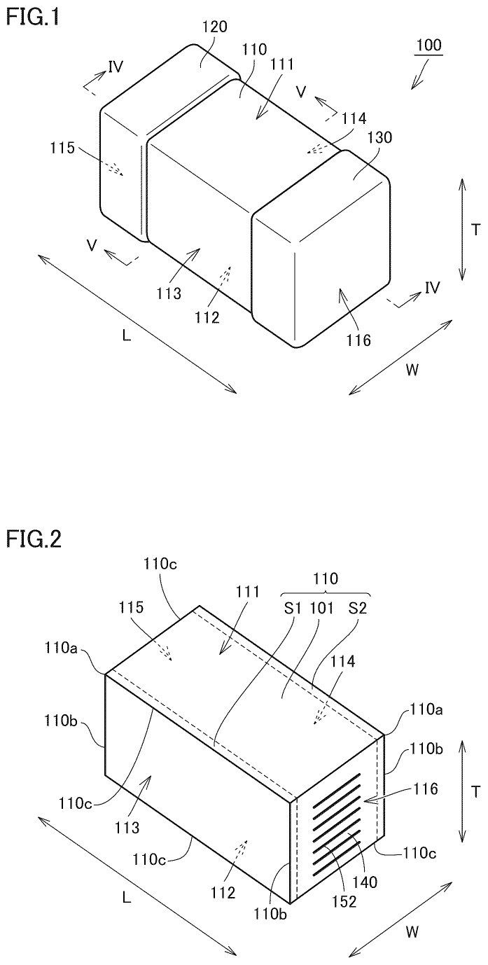

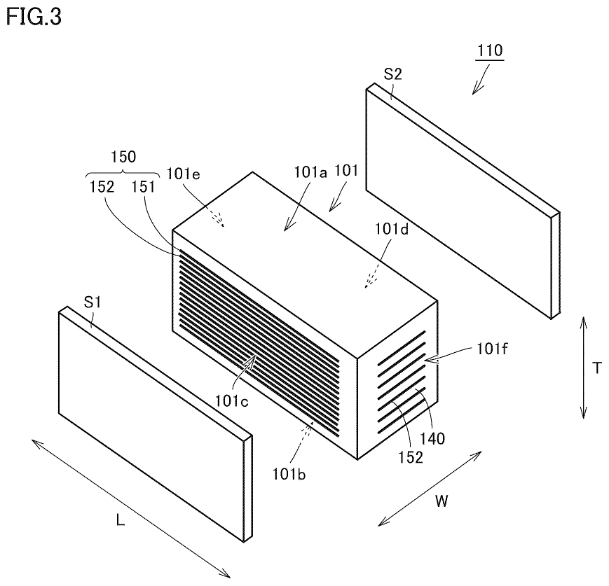

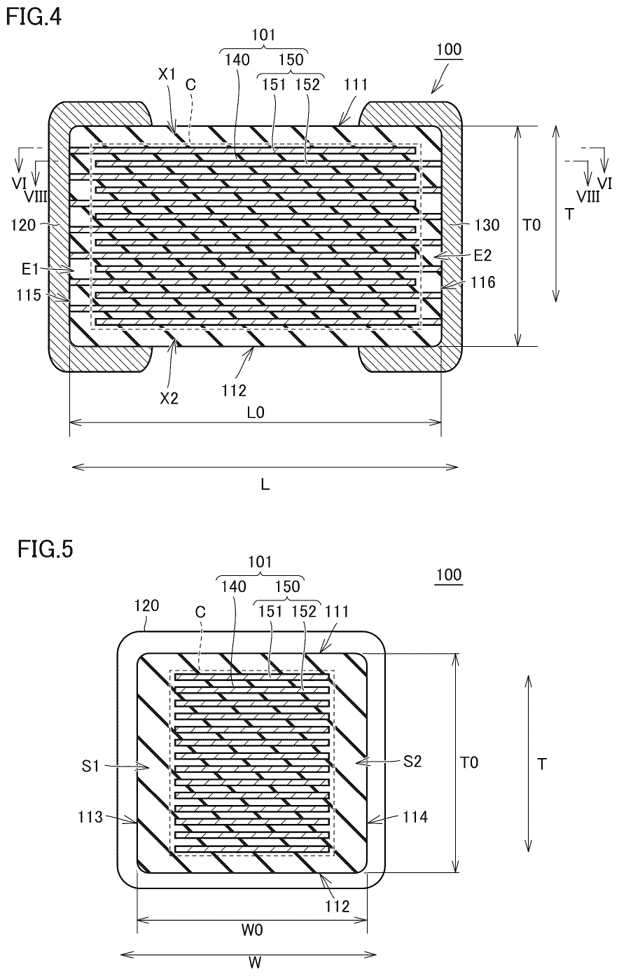

FIG. 1 is a perspective view schematically showing an appearance of a multilayer ceramic capacitor according to an example embodiment of the present invention. FIG. 2 is a schematic perspective view of an element body portion of the multilayer ceramic capacitor according to the present example embodiment. FIG. 3 is an exploded perspective view for schematically illustrating a configuration of the element body portion shown in FIG. 2. FIG. 4 is a schematic sectional view taken along the line IV-IV shown in FIG. 1. FIG. 5 is a schematic sectional view taken along the line V-V shown in FIG. 1. A configuration of a multilayer ceramic capacitor 100 according to the present example embodiment will be described with reference to FIGS. 1 to 5.

As shown in FIGS. 1 to 5, multilayer ceramic capacitor 100 according to the present example embodiment includes an element body portion 110 and an external electrode. Multilayer ceramic capacitor 100 includes a first external electrode 120 and a second external electrode 130 as the external electrode.

Element body portion 110 has a rectangular or substantially rectangular parallelepiped shape. Element body portion 110 includes a first main surface 111 and a second main surface 112 opposite to each other in a stacking direction T, a first side surface 113 and a second side surface 114 opposite to each other in a width direction W that is orthogonal or substantially orthogonal to stacking direction T, and a first end surface 115 and a second end surface 116 opposite to each other in a length direction L that is orthogonal or substantially orthogonal to stacking direction T and width direction W.

Element body portion 110 includes a plurality of corner portions 110a. Corner portion 110a is a portion at which three surfaces of element body portion 110 intersect one another. In other words, the plurality of corner portions 110a include portions at which three adjacent surfaces of first main surface 111, second main surface 112, first side surface 113, second side surface 114, first end surface 115, and second end surface 116 intersect one another. All of the plurality of corner portions 110a are preferably rounded.

Element body portion 110 includes a plurality of ridge portions 110b. The plurality of ridge portions 110b include portions at which two adjacent surfaces of first side surface 113, second side surface 114, first end surface 115, and second end surface 116 intersect each other. All of the plurality of ridge portions 110b are preferably rounded.

Element body portion 110 includes a plurality of main-surface-side ridge portions 110c. The plurality of main-surface-side ridge portions 110c include portions at which first main surface 111 intersects each of first side surface 113, second side surface 114, first end surface 115, and second end surface 116, and portions at which second main surface 112 intersects each of first side surface 113, second side surface 114, first end surface 115, and second end surface 116. All of the plurality of main-surface-side ridge portions 110c are preferably rounded.

As shown in FIGS. 1 and 4, first external electrode 120 is provided on first end surface 115. Specifically, first external electrode 120 is provided on the entire or substantially the entire first end surface 115 and wraps around from first end surface 115 to first main surface 111, second main surface 112, first side surface 113, and second side surface 114.

Second external electrode 130 is provided on second end surface 116. Specifically, second external electrode 130 is provided on the entire or substantially the entire second end surface 116 and is wraps around from second end surface 116 to first main surface 111, second main surface 112, first side surface 113, and second side surface 114.

First external electrode 120 and second external electrode 130 include, for example, a base electrode layer and a plating layer disposed on the base electrode layer. The base electrode layer includes at least one layer of a baked electrode layer, a resin electrode layer, a thin electrode layer, or any other layer.

The baked electrode layer is a layer including glass and metal, and may be a single layer or include a plurality of layers. The baked electrode layer includes, for example, one metal of Ni, Cu, Ag, Pd, or Au, or an alloy including the metal, and includes, for example, an alloy of Ag and Pd.

The baked electrode layer can be formed by applying a conductive paste including glass and metal to element body portion 110 and then baking the conductive paste. Baking may be performed simultaneously with firing of element body portion 110, or may be performed after firing of element body portion 110.

The resin electrode layer can include, for example, a layer including conductive particles and a thermosetting resin. In the formation of the resin electrode layer, the resin electrode layer may be formed directly on element body portion 110 without the formation of the baked electrode layer. The resin electrode layer may be a single layer or include a plurality of layers.

The thin electrode layer is, for example, a layer having a thickness of about 1 μm or less with deposited metal particles, and can be formed by a known thin film formation method such as sputtering or vapor deposition, for example.

The plating layer disposed on the base electrode layer includes, for example, one of Ni, Cu, Ag, Pd, or Au, or an alloy including such a metal, and includes, for example, an alloy of Ag and Pd. The plating layer may be a single layer or include a plurality of layers. However, the plating layer preferably has a two-layer structure including, for example, a Sn plating layer provided on a Ni plating layer. The Ni plating layer prevents the underlayer electrode layer from being eroded by the solder when multilayer ceramic capacitor 100 is mounted. The Sn plating layer improves the wettability of the solder when multilayer ceramic capacitor 100 is mounted.

Each of first external electrode 120 and second external electrode 130 may include a plating layer directly disposed on element body portion 110 without a base electrode layer. In this case, the plating layer is directly connected to first internal electrode layers 151 or second internal electrode layers 152, which will be described later. The following will describe the details of the plating layer in the case where each of first external electrode 120 and second external electrode 130 do not include a base electrode layer and includes a plating layer directly formed on element body portion 110.

The plating layer preferably includes a first plating layer provided on element body portion 110 and a second plating layer provided on the first plating layer. However, when the plating layer is formed by, for example, an electroless plating method, a catalyst may be provided on element body portion 110.

Each of the first plating layer and the second plating layer preferably includes, for example, one metal of Cu, Ni, Sn, Pb, Au, Ag, Pd, Bi, or Zn, or an alloy including the metal.

When Ni is used as the internal electrode layer, for example, Cu, which has excellent bonding properties with Ni, is preferably used as the first plating layer. Also, for example, Sn or Au, which has good solder wettability, is preferably used as the second plating layer. Also, for example, Ni, which has solder barrier properties, may be used as the first plating layer.

The second plating layer may be provided as necessary. In other words, each of first external electrode 120 and second external electrode 130 may include only the first plating layer. Alternatively, each of first external electrode 120 and second external electrode 130 may include the first plating layer and the second plating layer, as well as another plating layer provided on the second plating layer.

The ratio of the metal to per unit area of the plating layer is, for example, preferably about 99% by volume or more. The plating layer preferably includes no glass. The plating layer is preferably grain-grown in its thickness direction, and in this case, the plating layer is formed in a columnar shape.

As shown in FIGS. 2 and 3, element body portion 110 includes a multilayer body 101 and a side margin portion. The side margin portion includes a first side margin portion S1 and a second side margin portion S2.

Multilayer body 101 includes a pair of main surfaces 101a, 101b opposite to each other in stacking direction T, a pair of side surfaces 101c, 101d opposite to each other in width direction W, and a pair of end surfaces 101e, 101f opposite to each other in length direction L.

The pair of main surfaces 101a, 101b define a portion of first main surface 111 and second main surface 112 of element body portion 110. Side surface 101c is covered with first side margin portion S1. Side surface 101d is covered with second side margin portion S2. The pair of end surfaces 101e, 101f define a portion of first end surface 115 and second end surface 116 of element body portion 110.

As shown in FIGS. 3 to 5, multilayer body 101 includes a plurality of dielectric layers 140 and a plurality of internal electrode layers 150, which are alternately stacked along stacking direction T.

The plurality of internal electrode layers 150 include the plurality of first internal electrode layers 151 and the plurality of second internal electrode layers 152. The plurality of first internal electrode layers 151 and the plurality of second internal electrode layers 152 are stacked alternately in stacking direction T.

The plurality of first internal electrode layers 151 extend to first end surface 115. The plurality of first internal electrode layers 151 are connected to first external electrode 120. The plurality of second internal electrode layers 152 extend to second end surface 116. The plurality of second internal electrode layers 152 are connected to second external electrode 130. The opposite ends of the plurality of first internal electrode layers 151 and the plurality of second internal electrode layers 152 in width direction W are exposed on side surfaces 101c, 101d.

FIGS. 2 to 5 show an example in which seven first internal electrode layers 151 and seven second internal electrode layers 152 are provided, but the number of each of first internal electrode layers 151 and second internal electrode layers 152 is not limited to seven. The number of internal electrode layers 150 is, for example, preferably 50 or more and 300 or less. From the viewpoint of smaller size and higher capacitance of the multilayer ceramic capacitor, the thickness of internal electrode layer 150 is, for example, preferably about 0.4 μm or more and about 0.9 μm or less.

Each of first internal electrode layer 151 and second internal electrode layer 152 includes, for example, one metal of Ni, Cu, Ag, Pd, or Au, or an alloy including the metal, and includes, for example, an alloy of Ag and Pd. In the present example embodiment, each of first internal electrode layer 151 and second internal electrode layer 152 mainly includes, for example, Ni. Each of first internal electrode layer 151 and second internal electrode layer 152 may further include, for example, dielectric particles of the same composition as that of the ceramic included in dielectric layer 140. Each of first internal electrode layer 151 and second internal electrode layer 152 may include, for example, Sn at the interface with dielectric layer 140.

The plurality of dielectric layers 140 include an outer dielectric layer located between internal electrode layer 150 located closest to first main surface 111 in stacking direction T and first main surface 111, an outer dielectric layer located between internal electrode layer 150 located closest to second main surface 112 in stacking direction T and second main surface 112, and inner dielectric layers located between internal electrode layers 150 adjacent to each other in stacking direction T. The number of the plurality of dielectric layers 140 is, for example, preferably 100 or more and 500 or less. From the viewpoint of smaller size and higher capacitance of the multilayer ceramic capacitor, the thickness of each of the plurality of dielectric layers 140 is, for example, preferably about 0.5 μm or more and about 0.8 μm or less.

Each of the plurality of dielectric layers 140 may include a dielectric ceramic including, for example, a component such as BaTiO₃, CaTiO₃, SrTiO₃, or CaZrO₃ as a ceramic material. In addition, a material including the main component and a secondary component such as, for example, a Mn compound, an Fe compound, a Cr compound, a Co compound, or a Ni compound may be used. In this case, the content of the secondary component is smaller than the content of the main component.

As shown in FIG. 4, multilayer body 101 is divided into an inner layer portion C, a first outer layer portion X1, a second outer layer X2, a first end margin portion E1, and a second end margin portion E2. Inner layer portion C generates a capacitance by stacking first facing portions 151C (which will be described later) of first internal electrode layers 151 and second facing portions 152C (which will be described later) of second internal electrode layers 152 in stacking direction T.

First outer layer portion X1 and second outer layer portion X2 sandwich inner layer portion C in stacking direction T. First outer layer portion X1 is located outside inner layer portion C in stacking direction T, and is located on the first main surface 111 side. Second outer layer portion X2 is located outside inner layer portion C in stacking direction T, and is located on the second main surface 112 side. The thickness of each of first outer layer portion X1 and second outer layer portion X2 is, for example, preferably about 30 μm or more and about 50 μm or less.

Each of first outer layer portion X1 and second outer layer portion X2 is an outer dielectric layer and includes a dielectric ceramic material mainly including, for example, a perovskite compound including Ba and Ti. First outer layer portion X1 and second outer layer portion X2 may be made of the same dielectric ceramic material as that of the plurality of dielectric layers 140, or may be made of a dielectric ceramic material different from that of the plurality of dielectric layers 140. In the present example embodiment, the outer dielectric layer has a higher Mn content than that of the inner dielectric layer. In other words, the amount of Mn in first outer layer portion X1 and second outer layer portion X2 is greater than that of dielectric layer 140 of multilayer body 101 (more specifically, the inner dielectric layer of inner layer portion C). Consequently, first outer layer portion X1 and second outer layer portion X2 can be made denser for improved moisture resistance, thus ensuring the moisture resistance of multilayer ceramic capacitor 100.

First end margin portion E1 and second end margin portion E2 sandwich inner layer portion C in length direction L. First end margin portion E1 is located outside inner layer portion C in length direction L and is located on the first end surface 115 side. Second end margin portion E2 is located outside inner layer portion C in length direction L and is located on the second end surface 116 side.

The side margin portions are located in element body portion 110, in width direction W, between first side surface 113 and the plurality of internal electrode layers 150 and between second side surface 114 and the plurality of internal electrode layers 150.

Specifically, first side margin portion S1 covers the entire or substantially the entire side surface 101c of multilayer body 101. First side margin portion S1 is provided in element body portion 110 from one end of internal electrode layer 150 which is located on one side in width direction W to first side surface 113.

Second side margin portion S2 covers the entire or substantially the entire side surface 101d of multilayer body 101. Second side margin portion S2 is provided in element body portion 110 from the other end of internal electrode layer 150 which is located on the other side in width direction W to second side surface 114.

First side margin portion S1 and second side margin portion S2 include a dielectric ceramic material mainly including, for example, a perovskite compound including Ba and Ti. First side margin portion S1 and second side margin portion S2 may be made of the same dielectric ceramic material as that of the plurality of dielectric layers 140, or may be made of a dielectric ceramic material different from that of the plurality of dielectric layers 140.

First side margin portion S1 and second side margin portion S2 may include, for example, at least one of Si or Mg, or may include Mn.

In first side margin portion S1 and second side margin portion S2, for example, Si may be segregated. Specifically, Si may be segregated in the portion of first side margin portion S1 which is on the side surface 101c side, and Si may be segregated in the portion of second side margin portion S2 which is on the side surface 101d side. The segregation of Si can be checked by observing a cross section with, for example, a SEM/EDX. Mn can be checked by observing the main component, such as, for example, Ba or Ti, with an EPMA or the like.

In the present example embodiment, first side margin portion S1 and second side margin portion S2 each include a single layer. First side margin portion S1 and second side margin portion S2 may also include a plurality of layers stacked in width direction W. In the plurality of layers, an interface between layers does not necessarily have to be observed, and for example, the grain diameter may differ between on the side surface side and on the internal electrode layer 150 side, that is, the grain diameter may differ in width direction W. The grain diameter can be measured with an electron microscope such as TEM. For example, the area of the grains in a field of view is measured in an area of about 10 μm by about 10 μm. The comparable circle diameter of each grain is calculated by area conversion, and the average value of the comparable circle diameter is used as the grain diameter.

As described above, the size of multilayer ceramic capacitor 100 including element body portion 110, first external electrode 120, and second external electrode 130 is not particularly limited, but for example, the following ranges can be used.

As shown in FIG. 4, a maximum distance L0 between first end surface 115 and second end surface 116 of element body portion 110 is preferably, for example, about 0.2 mm or more and about 1.0 mm or less. A maximum distance TO between first main surface 111 and second main surface 112 of element body portion 110 is preferably, for example, about 0.1 mm or more and about 0.5 mm or less. As shown in FIG. 5, a maximum distance W0 between first side surface 113 and second side surface 114 of element body portion 110 is preferably, for example, about 0.1 mm or more and about 0.5 mm or less.

Element body portion 110 has, for example, a size with length dimension L0 of about 0.6 mm, width dimension W0 of about 0.3 mm, and thickness dimension TO of about 0.3 mm. Tolerances are also included in the above sizes.

### B. Specific Configuration of Internal Electrode Layer

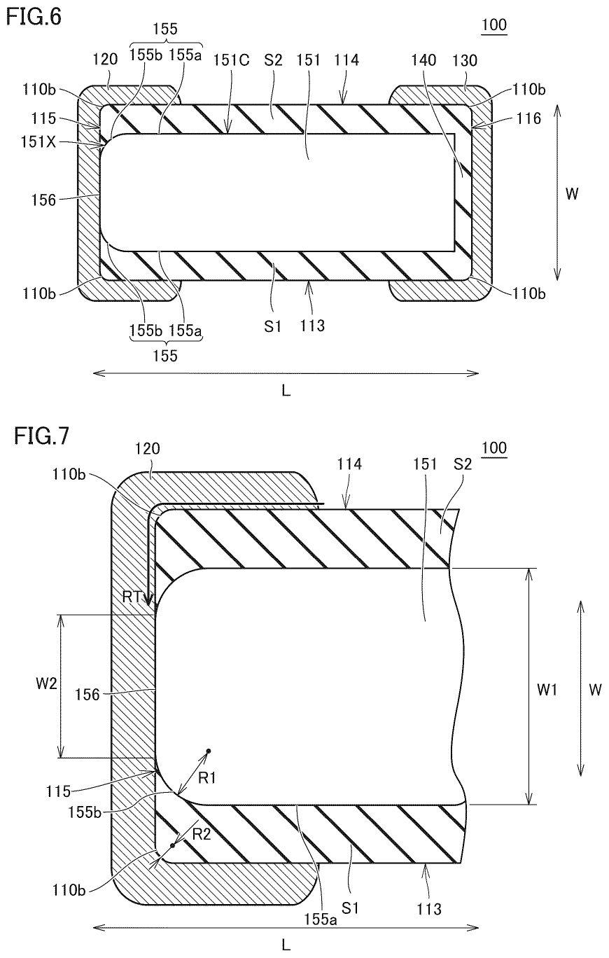

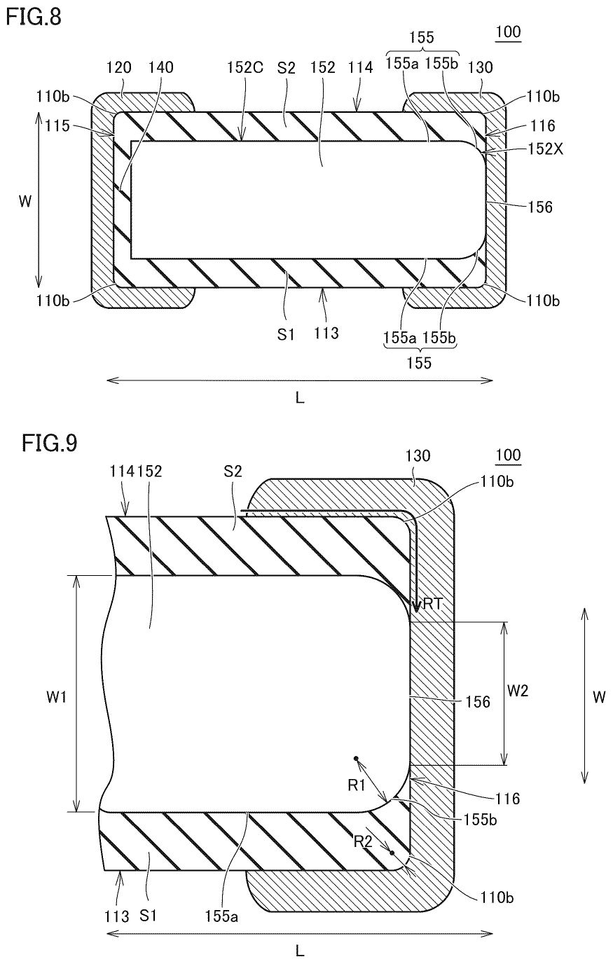

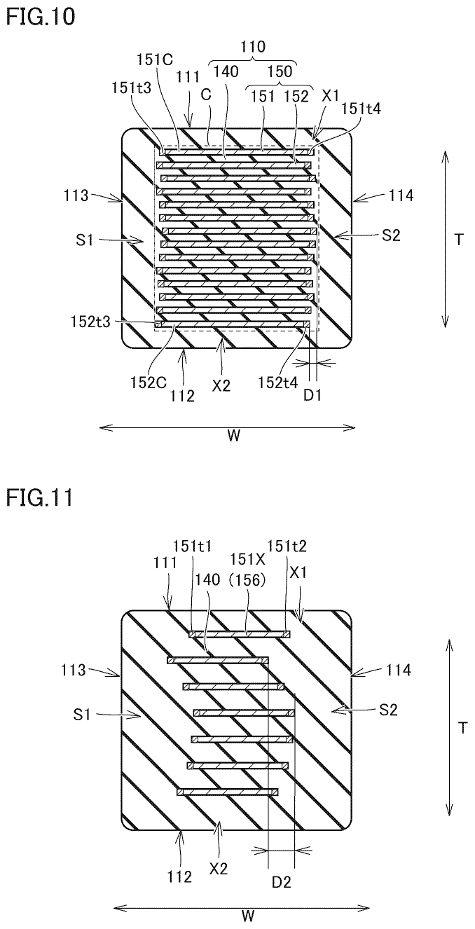

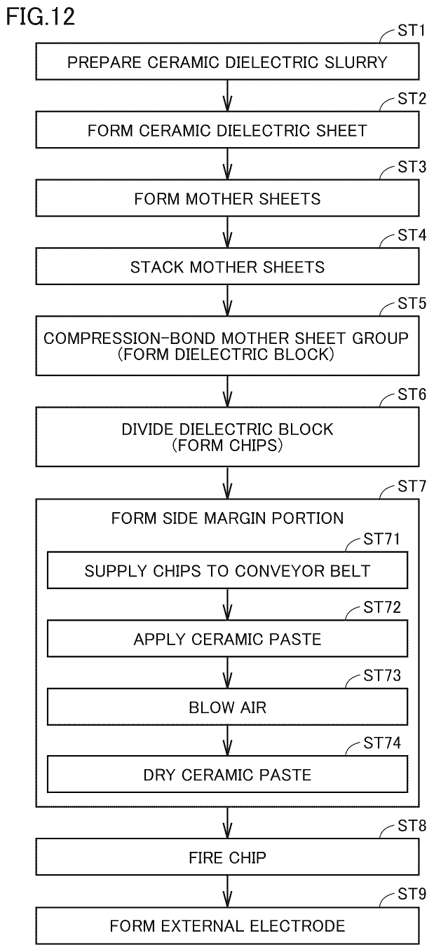

FIG. 6 is a schematic sectional view taken along the line VI-VI shown in FIG. 4. FIG. 7 is an enlarged schematic sectional view of a connection end and its vicinity shown in FIG. 6. FIG. 8 is a schematic sectional view taken along the line VIII-VIII shown in FIG. 4. FIG. 9 is an enlarged schematic sectional view of a connection end and its vicinity shown in FIG. 8. FIG. 10 is a schematic sectional view for illustrating a state of facing portions of internal electrode layers in the multilayer ceramic capacitor according to the present example embodiment. Specifically, FIG. 10 shows a cross section of element body portion 110 parallel or substantially parallel to stacking direction T and width direction W at the central portion of element body portion 110 in length direction L. FIG. 11 is a schematic sectional view for illustrating a state in which lead portions of the internal electrode layers are led out in the multilayer ceramic capacitor according to the example embodiment. Specifically, FIG. 11 shows a cross section of element body portion 110 parallel or substantially parallel to stacking direction T and width direction W at the end of element body portion 110 in length direction L. Detailed configurations of first internal electrode layer 151 and second internal electrode layer 152 will be described with reference to FIGS. 6 to 11.

FIGS. 10 and 11 are shown for illustrating the displacement amount of the facing portions and the displacement amount of the lead portions, respectively, and the shape of element body portion 110, the position of the facing portion, the position of the lead portion, and the like are not limited to the manner shown in FIGS. 10 and 11.

As shown in FIGS. 6 and 7, first internal electrode layer 151 includes a first facing portion 151C and a first lead portion 151X. First facing portion 151C faces second internal electrode layer 152 adjacent in stacking direction T. First lead portion 151X extends to first end surface 115. As a result, first lead portion 151X connects first facing portion 151C to first external electrode 120. First facing portion 151C and first lead portion 151X are integrated.

As shown in FIGS. 8 and 9, second internal electrode layer 152 includes a second facing portion 152C and a second lead portion 152X. Second facing portion 152C faces first internal electrode layer 151 adjacent in stacking direction T. Second lead portion 152X extends to second end surface 116. As a result, second lead portion 152X connects second facing portion 152C to second external electrode 130. Second facing portion 152C and second lead portion 152X are integrated.

When first facing portion 151C and second facing portion 152C are not particularly distinguished from each other, they may simply be referred to as facing portions, and when first lead portion 151X and second lead portion 152X are not particularly distinguished from each other, they may simply be referred to as lead portions. Similarly, when first internal electrode layer 151 and second internal electrode layer 152 are not particularly distinguished from each other, they may simply be referred to as internal electrode layers. When first external electrode 120 and second external electrode 130 are not particularly distinguished from each other, they may simply be referred to as external electrodes.

As shown in FIGS. 6 to 9, opposite edges 155 of each of the plurality of internal electrode layers 150 in width direction W include two straight portions 155a and two curved portions 155b respectively connected to these two straight portions 155a. Two straight portions 155a extend linearly in length direction L while being spaced apart from each other in width direction W. TWO curved portions 155b are curved at such a curvature to cause the two curved portions to approach each other in width direction W with an increasing distance from the two straight portions 155a in length direction L.

First side margin portion S1 and second side margin portion S2 are located outside opposite edges 155 in width direction W so as to cover opposite edges 155. As a result, the thickness of the portion of first side margin portion S1 which covers the two curved portions 155b in width direction W is set to be greater than the thickness of the portion of first side margin portion S1 which covers the two straight portions 155a in width direction W. The same is true for second side margin portion S2.

In the present example embodiment, of opposite edges 155 of each of the plurality of internal electrode layers 150, the portions corresponding to the plurality of facing portions include two straight portions 155a alone. In addition, of opposite edges 155 of each of the plurality of internal electrode layers 150, the portions corresponding to the plurality of lead portions include two curved portions 155b alone.

A connection end 156, which is located at the end in length direction L in each of the plurality of internal electrode layers 150 and is connected to the external electrode, is connected to two curved portions 155b. With this configuration, a multilayer ceramic capacitor with an improved moisture resistance can be provided, which will be described later in detail.

As shown in FIGS. 7 and 9, the curvature of each of the two curved portions 155b is preferably set to be smaller than the curvature of ridge portion 110b. Specifically, when the radius of curvature of each of the two curved portions 155b is R1 and the radius of curvature of ridge portion 110b is R2, R1>R2 is preferably satisfied.

Radius of curvature R1 of each of the two curved portions 155b is, for example, preferably about 20% or more and about 40% or less of dimension W1 of the portion of the facing portion which has the largest dimension in width direction W. Radius of curvature R1 is, for example, preferably about 10 μm or more and about 40 μm or less.

A width W2 of connection end 156 of each of the plurality of internal electrode layers 150 in width direction W is, for example, preferably about 60% or more and about 80% or less of dimension W1 described above.

As shown in FIG. 10, a maximum displacement amount D1, which is the displacement amount in width direction W between the facing portion located closest to first side surface 113 and the facing portion located closest to second side surface 114 among the plurality of facing portions (more specifically, the plurality of first facing portions 151C and the plurality of second facing portions 152C), is, for example, about 5 μm or less. In other words, in the cross section taken along stacking direction T and width direction W at the central portion of element body portion 110 in length direction L, maximum displacement amount D1 in width direction W in the plurality of internal electrode layers 150 is, for example, about 5 μm or less.

As shown in FIG. 11, a maximum displacement amount D2, which is the displacement amount in width direction W between first lead portion 151X located closest to first side surface 113 and first lead portion 151X located closest to second side surface 114 among the plurality of first lead portions 151X, is, for example, about 5 μm or less. Also in the plurality of second lead portions 152X, the maximum displacement amount described above is the same as maximum displacement amount D2 in first lead portion 151X. In other words, in each of first end surface 115 and second end surface 116 of element body portion 110, the maximum displacement amount in width direction W at connection end 156 in the plurality of internal electrode layers 150 is, for example, about 5 μm or less.

In this manner, when the ends of the plurality of first lead portions 151X in the width direction are not aligned in stacking direction T but are displaced in width direction W, portions of internal electrode layers 150 adjacent to each other in the thickness direction may be in close proximity to one of opposite ends 151t1, 151t2 of the plurality of first lead portions 151X in the width direction.

In the present example embodiment, for example, Mg is segregated in opposite ends 151t1, 151t2 of each of the plurality of first lead portions 151X in width direction W. This improves the insulation of opposite ends 151t1, 151t2, and thus, even if one of opposite ends 151t1, 151t2 is in close proximity to internal electrode layer 150 adjacent in the thickness direction, the occurrence of a short circuit can be reduced or prevented. As a result, the reliability of multilayer ceramic capacitor 100 can be improved. Mg is also segregated in the ends of each of the plurality of second lead portions 152X in the width direction, and the same or substantially the same advantageous effects as the above-described advantageous effects can be obtained.

Mg is segregated also in opposite ends 151t3, 151t4 of each of the plurality of first facing portions 151C in width direction W, and Mg is also segregated at opposite ends 152t3, 152t4 of each of the plurality of second facing portions 152C in width direction W. In other words, Mg is segregated at opposite edges 155 of each of the plurality of internal electrode layers 150 in width direction W. This also achieves the same or substantially the same advantageous effects as the advantageous effects described above. The depth of the Mg segregation layer provided on opposite edges 155 (more particularly, the dimension of the segregation layer in width direction W) is preferably uniform in length direction L. The segregation of Mg can be checked by observing a cross section parallel or substantially parallel to width direction W and length direction L of element body portion 110 with, for example, a SEM/EDX.

The shape and length relationships described above with reference to FIG. 10 can be obtained by exposing a cross section, which passes through the central portion of element body portion 110 in length direction L and is parallel or substantially parallel to width direction W and stacking direction T, by, for example, polishing or any other method, and then observing the cross section with an optical microscope, an electron microscope, or the like.

The shape and length relationships described above with reference to FIG. 11 can be obtained by polishing element body portion 110 until first end surface 115 is exposed from the first external electrode 120 side, and then observing a cross section of element body portion 110 parallel or substantially parallel to stacking direction T and width direction W with an optical microscope, an electron microscope, or the like.

In observation with an optical microscope or an electron microscope, a bright field and a dark field are preferably used for different purposes as necessary.

### C. Summary

In multilayer ceramic capacitor 100 according to the present example embodiment, as described above, opposite edges 155 of each of the plurality of internal electrode layers 150 in width direction W include two straight portions 155a and two curved portions 155b. In addition, connection end 156 of each of the plurality of internal electrode layers 150 is connected to two curved portions 155b.

With this configuration, the moisture infiltration path from first side surface 113 or second side surface 114 of element body portion 110 through first end surface 115 or second end surface 116 to connection end 156 exposed on first end surface 115 or second end surface 116 (see the arrows RT in FIGS. 7 and 9) can be made longer than the above-described path in the case where opposite edges 155 only include straight portions 155a.

Thus, moisture that has infiltrated toward the interior of multilayer ceramic capacitor 100 less easily reaches internal electrode layer 150, and as a result, the moisture resistance of multilayer ceramic capacitor 100 can be improved.

Multilayer ceramic capacitor 100 according to the present example embodiment configured as described above can thus have an improved moisture resistance.

In multilayer ceramic capacitor 100 according to the present example embodiment, as described above, the curvature of each of the two curved portions 155b is set to be smaller than the curvature of ridge portion 110b. With this configuration, the moisture infiltration path described above can be made even longer. As a result, the moisture resistance of multilayer ceramic capacitor 100 can be improved further.

In multilayer ceramic capacitor 100 according to the present example embodiment described above, description has been provided with regard to the case where the portions of opposite edges 155 of each of the plurality of internal electrode layers 150 which correspond to the plurality of facing portions include two straight portions 155a alone, and the portions of opposite edges 155 of each of the plurality of internal electrode layers 150 which correspond to the plurality of lead portions include two curved portions 155b alone, but the configuration of opposite edges 155 of each of the plurality of internal electrode layers 150 is not particularly limited to this configuration.

In other words, portions of opposite edges 155 of each of the plurality of internal electrode layers 150 which correspond to the plurality of facing portions may include portions of the two straight portions 155a alone, and portions of opposite edges 155 of each of the plurality of internal electrode layers 150 which correspond to the plurality of lead portions may include the remaining portions of the two straight portions 155a and two curved portions 155b. Alternatively, the portions of opposite edges 155 of each of the plurality of internal electrode layers 150 which correspond to the plurality of facing portions may include two straight portions 155a and portions of two curved portions 155b, and the portions of opposite edges 155 of each of the plurality of internal electrode layers 150 which correspond to the plurality of lead portions may include the remaining portions of the two curved portions 155b alone.

### D. Method of Manufacturing Multilayer Ceramic Capacitor

FIG. 12 is a flowchart showing an example of a method of manufacturing a multilayer ceramic capacitor according to an example embodiment of the present invention. Description will be provided with regard to a method of manufacturing multilayer ceramic capacitor 100 according to the present example embodiment.

As shown in FIG. 12, first, a ceramic dielectric slurry is prepared (step ST1). Specifically, for example, ceramic dielectric powders, additive powders, a binder resin, a solution, and the like are subjected to dispersive mixing. Consequently, a ceramic dielectric slurry is prepared.

The ceramic dielectric powders are, for example, dielectric particles having a perovskite structure, such as BaTiO₃, CaTiO₃, SrTiO₃, CaZrO₃, or CaHfO₃. The additive powders include, for example, at least one of a Si compound, a Mg compound, a Mn compound, an Fe compound, a Cr compound, a Ni compound, or a Co compound. The binder resin may be, for example, polyurethane resin, urea resin, melamine resin, epoxy resin, vinyl acetate resin, acrylic resin, or an aqueous polymer such as polyvinyl alcohol (PVA) or polyvinyl butyral (PVB). One of these may be used, or a mixture of two or more of these may be used. The ceramic dielectric slurry may be solvent-based or water-based. When the ceramic dielectric slurry is used as a water-based coating, for example, the ceramic dielectric slurry is prepared by mixing a water-soluble binder, a dispersant, or the like with a dielectric material dissolved in water.

Subsequently, a ceramic dielectric sheet is formed (step ST2). Specifically, the ceramic dielectric slurry is formed in a sheet shape with, for example, a die coater, a gravure coater, a micro-gravure coater, or the like on a carrier film and is then dried. Consequently, a ceramic dielectric sheet is formed.

Subsequently, a mother sheet is formed (step ST3). Specifically, a conductive paste is applied to the ceramic dielectric sheet to have a prescribed pattern. Consequently, a mother sheet with a prescribed internal electrode pattern is formed on the ceramic dielectric sheet. The conductive paste includes, for example, Ni powders, a solvent, a dispersant, a binder, and the like and is prepared to have a constant viscosity. PVA, PVB, or the like, for example, is used as the binder. Screen printing, ink jet printing, gravure printing, or any other printing, for example, may be used as the method of applying a conductive paste. In addition to the mother sheet with the internal electrode pattern, a ceramic dielectric sheet that has not been subjected to step ST3 described above is also prepared as the mother sheet.

Subsequently, a plurality of mother sheets are stacked (step ST4). Specifically, a prescribed number of mother sheets, each including a ceramic dielectric sheet alone without an internal electrode pattern, are stacked. Thereon, a prescribed number of mother sheets with internal electrode patterns are stacked. Further, thereon, a prescribed number of mother sheets including only ceramic dielectric sheets without internal electrode patterns are stacked. Consequently, a mother sheet group is formed.

Subsequently, a dielectric block is formed by compression bonding of the mother sheet group (step ST5). Specifically, the mother sheet group is compression-bonded in the stacking direction by, for example, hydrostatic pressing or rigid pressing. Consequently, a dielectric block is formed. At this time, the ceramic dielectric sheets are pressed at a prescribed temperature to closely adhere to each other. In addition, ceramic dielectric sheets for a certain thickness are disposed on the outermost layer in the stacking direction and pressed. Consequently, a dielectric sheet with an internal electrode pattern can be protected.

Subsequently, the dielectric block is divided into chips (step ST6). Specifically, the dielectric block is divided into matrices by, for example, press cutting, dicing, or laser cutting into individual chips. In dividing of the dielectric block, the dielectric block softened by heating may be divided.

Subsequently, a side margin portion is formed (step ST7). This step includes steps ST71 to ST74, which will be described below.

First, the individual chips are sequentially supplied onto a conveyor belt (step ST71). The chips supplied onto the conveyor belt are placed on the conveyor belt while being oriented such that one of the surface that defines first side surface 113 or the surface that defines second side surface 114 of element body portion 110 after being subjected to a firing step (step ST8), which will be described later, faces the conveyor belt. The chips placed on the conveyor belt in this manner are sequentially transported by the conveyor belt in a prescribed transport direction.

Of the surface that defines first side surface 113 and the surface that defines second side surface 114 of the chip, the surface opposite to the surface that faces the conveyor belt is also referred to as an exposed surface.

Subsequently, a ceramic paste is applied to the exposed surface (step ST72). Specifically, the ceramic paste is dripped from a dispenser disposed to face the conveyor belt toward the exposed surface of the chip.

The ceramic paste includes a dielectric ceramic material mainly including, for example, a perovskite compound including Ba and Ti, a solvent, and the like, and is prepared to have a constant viscosity. The solvent is, for example, water or an organic solvent such as alcohol.

The ceramic paste is not particularly limited to this and can be selected as appropriate in accordance with, for example, characteristics of multilayer ceramic capacitor 100. For example, the ceramic paste may include the same type of ceramic dielectric powders as that of the ceramic dielectric powders included in the ceramic dielectric sheet described above or may include a different type of ceramic dielectric powders from that of the ceramic dielectric powders included in the ceramic dielectric sheet.

The viscosity of the ceramic paste is, for example, preferably within the range from about 5 mPa·s to about 1000 mPa·s when the ceramic paste is dripped. In other words, the viscosity of the ceramic paste is, for example, preferably within the range from about 5 mPa·s to about 1,000 mPa·s at the ambient temperature at which the ceramic paste is applied. Dripping of the ceramic paste from the exposed surface can be prevented by setting the viscosity of the ceramic paste to, for example, about 5 mPa·s or more, and the ceramic paste can be applied appropriately by setting the viscosity of the ceramic paste to, for example, about 1,000 mPa·s or less. Thus, a thin side margin portion with a uniform thickness can be formed.

The viscosity of the ceramic paste can be adjusted by changing the mixing ratio of the dielectric ceramic material and the solvent. Herein, the viscosity of the ceramic paste refers to the viscosity measured at a speed of, for example, about 10 rpm with an E-type viscometer.

The amount of dripped ceramic paste can be set appropriately in accordance with the thickness of the side margin portion to be formed on the exposed surface. The amount of dripped ceramic paste can be set to, for example, about 0.005 mm³ or more and about 1.0 mm³ or less.

Subsequently, air is blown onto the exposed surface (step ST73). Specifically, a blowing mechanism is disposed to face the conveyor belt at a position downstream of the position of the dispenser in the above-described transport direction. Air is blown from the blowing mechanism onto the exposed surface with the dripped ceramic paste. This causes the ceramic paste to spread evenly on the entire exposed surface.

The gas blown onto the exposed surface is not particularly limited to air, and any other gas, for example, nitrogen gas may be blown.

Subsequently, the ceramic paste is dried (step ST74). Specifically, a drying furnace is placed at a position downstream of the blowing mechanism in the above-described transport direction, and the chip is passed through the drying furnace. Consequently, the ceramic paste applied to the exposed surface is dried. Through steps ST71 to ST74 described above, a side margin portion is formed on one of the surface that defines first side surface 113 and the surface that defines second side surface 114 of the chip.

Subsequently, the orientation of the chip is changed, and then, steps ST72 to ST74 described above are performed on the chip.

Specifically, first, the orientation of the chip is changed such that, of the surface that defines first side surface 113 and the surface that defines second side surface 114 of the chip, the surface on the side on which the side margin portion is formed faces the conveyor belt. Consequently, of the surface that defines first side surface 113 and the surface that defines second side surface 114 of the chip, the surface on the side on which the side margin portion is not formed defines the above-described exposed surface. Subsequently, steps ST72 to ST74 described above are performed on the chip with its orientation changed in this manner. Consequently, the side margin portions are respectively formed on both the surface that defines first side surface 113 and the surface that defines second side surface 114 of the chip.

The orientation of the chip may be changed, for example, by a rotation mechanism including a holding unit configured to hold and rotate the chip.

Subsequently, the chip is fired (step ST8). Specifically, the dielectric material and the conductive material included in the chip are fired by heating the chip, thereby forming element body portion 110. The firing temperature is set to, for example, about 900° C. or higher and about 1300° C. or lower. The sintering temperature is set appropriately in accordance with the dielectric material and the conductive material.

Subsequently, an external electrode is formed (step ST9). Specifically, a paste mainly including, for example, Ni and also including a co-material that is a dielectric material is applied to the opposite end surfaces of element body portion 110. The application method may be, for example, a method of forming, on a plate, a paste layer that serves as the base electrode layer and immersing the end surface of element body portion 110 in the paste layer. After the application, element body portion 110 and the base electrode layer are fired together. After firing, plating is performed in order of, for example, Cu plating and Sn plating. The plating method is preferably electrolytic plating.

Multilayer ceramic capacitor 100 according to the present example embodiment can be manufactured through the steps described above.

### Modification 1

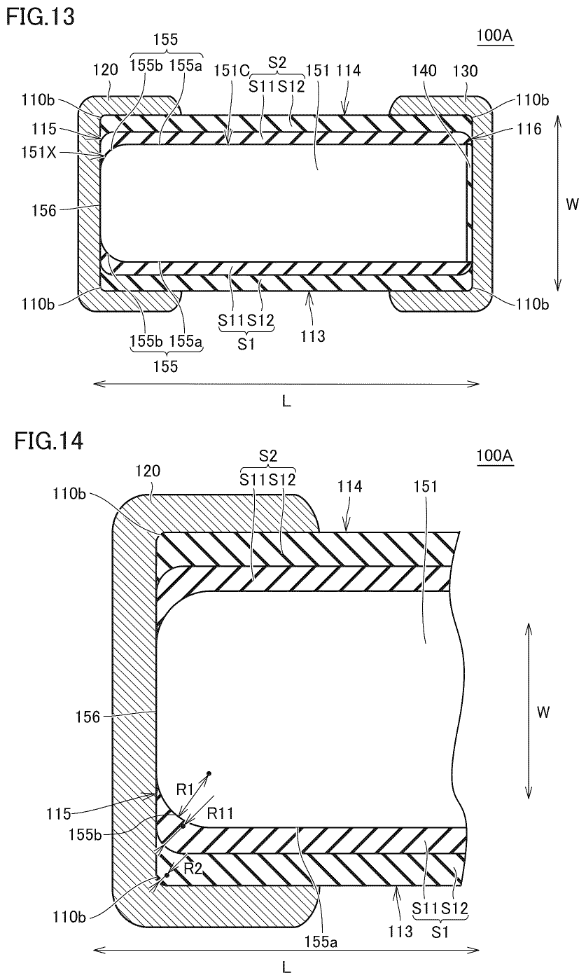

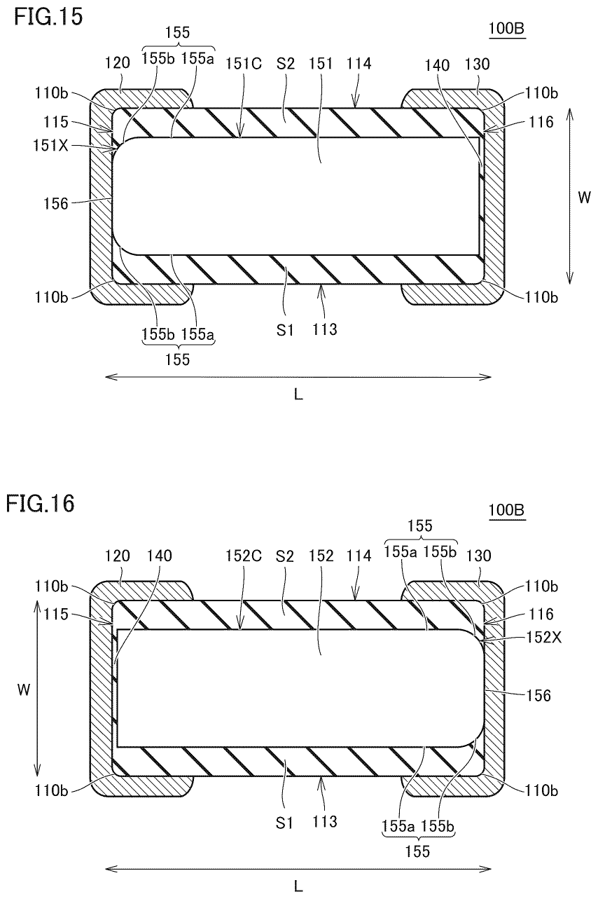

FIG. 13 is a schematic sectional view of a multilayer ceramic capacitor according to Modification 1 of an example embodiment of the present invention. More specifically, FIG. 13 is a schematic sectional view of the portion of the multilayer ceramic capacitor according to Modification 1 which corresponds to FIG. 6. FIG. 14 is an enlarged schematic sectional view of a connection end and its vicinity shown in FIG. 13. A multilayer ceramic capacitor 100A according to Modification 1 based on the above-described example embodiment will be described below with reference to FIGS. 13 and 14.

As shown in FIGS. 13 and 14, multilayer ceramic capacitor 100A according to the present modification differs from multilayer ceramic capacitor 100 according to the example embodiment described above in the configuration of the side margin portion of element body portion 110.

More specifically, in multilayer ceramic capacitor 100A, first side margin portion S1 and second side margin portion S2 each include a plurality of layers stacked in width direction W. In addition, an interface is provided between the plurality of layers. When first side margin portion S1 and second side margin portion S2 are not particularly distinguished from each other, they may simply be referred to as side margin portions below.

In the present modification, the side margin portion includes two layers including a first layer S11 and a second layer S12. First layer S11 is provided along the plurality of internal electrode layers 150. Second layer S12 is provided on the main surface of first layer S11 which is located on the outer side in width direction W so as to cover the main surface.

In the present modification, thus, first layer S11 corresponds to the innermost layer located on the innermost side in width direction W among the plurality of layers of the side margin portion, and second layer S12 corresponds to the outermost layer located on the outermost side in width direction W among the plurality of layers of the side margin portion.

The end of each of first layer S11 and second layer S12 on the connection end 156 side in length direction L is rounded.

The curvature of the surface of first layer S11 which is located on the outer side in width direction W is smaller than the curvature of the surface of second layer S12 which is located on the outer side in width direction W. In this manner, when the side margin portion includes a plurality of layers stacked in width direction W, the curvature of the surface of each of the above-described plurality of layers which is located on the outer side in width direction W increases from the inner side to the outer side in width direction W.

In the present modification, as described above, second layer S12 corresponds to the outermost layer. Thus, the curvature of the surface of second layer S12 which is located on the outer side in width direction W is equal or substantially equal to the curvature of ridge portion 110b.

Also with this configuration, the advantageous effects comparable to the advantageous effects described in the above example embodiment can be obtained, and a multilayer ceramic capacitor with an improved moisture resistance can be achieved.

In the present modification, thus, the curvature of the surface of first layer S11, which is the innermost layer, located on the outer side in width direction W is greater than the curvature of each of the two curved portions 155b of opposite edges 155 of internal electrode layer 150 and is smaller than the curvature of ridge portion 110b. Specifically, when the radius of curvature of the surface of first layer S11 which is located on the outer side in width direction W is R11, R1>R11>R2 is satisfied.

With this configuration, the moisture infiltration path described above can be made even longer. As a result, the moisture resistance of the multilayer ceramic capacitor can be improved further.

The side margin portion, which includes a plurality of layers as described above, can be formed by, for example, performing steps ST72 to ST74 of the above-described method of manufacturing multilayer ceramic capacitor 100 a plurality of times.

In multilayer ceramic capacitor 100A according to the present modification, the case where the side margin portion includes two layers has been described by way of example, but the number of layers of the side margin portion is not particularly limited to two, and may be three or more.

### Modification 2

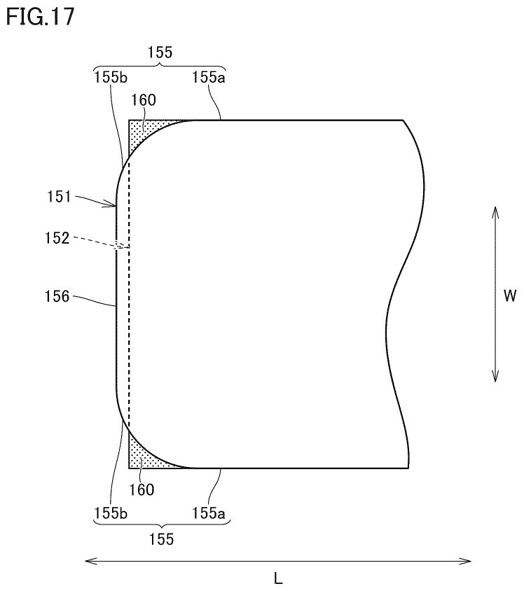

FIGS. 15 and 16 are schematic sectional views of a multilayer ceramic capacitor according to Modification 2 of an example embodiment of the present invention. More specifically, FIG. 15 is a schematic sectional view of the portion of the multilayer ceramic capacitor according to Modification 2 which corresponds to FIG. 6. FIG. 16 is a schematic sectional view of the portion of the multilayer ceramic capacitor according to Modification 2 which corresponds to FIG. 8. FIG. 17 is an enlarged schematic plan view for illustrating the positional relationship between the first internal electrode layer shown in FIG. 15 and the second internal electrode layer shown in FIG. 16. More specifically, FIG. 17 is an enlarged plan view of the end of the extracted first internal electrode layer, which is one of a plurality of first internal electrode layers, and the end of the extracted second internal electrode layer, which is adjacent to the first internal electrode layer in stacking direction T and is located below the first internal electrode layer, as viewed from the first main surface 111 side. A multilayer ceramic capacitor 100B according to Modification 2 based on the above-described example embodiment will be described below with reference to FIGS. 15 to 17. In FIG. 17, a pattern is added to the second internal electrode layer to facilitate understanding.

As shown in FIGS. 15 to 17, multilayer ceramic capacitor 100B according to the present modification differs from multilayer ceramic capacitor 100 according to the example embodiment described above in the configuration of internal electrode layer 150.

More specifically, in multilayer ceramic capacitor 100B, particularly as shown in FIG. 17, when first internal electrode layer 151 and second internal electrode layer 152, which is adjacent to first internal electrode layer 151 in stacking direction T, are viewed along stacking direction T, a pair of corners 160 of second internal electrode layer 152, which are located on the edges opposite to connection end 156 in length direction L and are located on opposite end edges in width direction W, protrude outside curved portion 155b of first internal electrode layer 151 in width direction W. Although not shown, the pair of corners of first internal electrode layer 151, which are located on the end edges opposite to connection end 156 in length direction L and are located on opposite end edges in width direction W, also protrude outside curved portion 155b of second internal electrode layer 152 in width direction W.

Also with this configuration, the advantageous effects comparable to those described in the above-described example embodiment can be obtained, and a multilayer ceramic capacitor with an improved moisture resistance can be achieved.

In addition, forming a pair of corners of first internal electrode layer 151 and a pair of corners 160 of second internal electrode layer 152 as described above can effectively reduce or prevent the occurrence of electric field concentration at these corners. As a result, the reliability of multilayer ceramic capacitor 100B can be improved.

In multilayer ceramic capacitor 100B according to the present modification, the case where a pair of corners of first internal electrode layer 151 and a pair of corners 160 of second internal electrode layer 152 protrude as described above has been described by way of example, but the pair of corners of only one of first internal electrode layer 151 and second internal electrode layer 152 may protrude as described above.

### OTHER EXAMPLE EMBODIMENTS

The shapes, configurations, sizes, numbers, materials, and the like of the components described in the above example embodiment of the present invention and the modifications thereof can be changed variously without departing from the scope of the present invention.

In addition, the characteristic features described in the above example embodiment of the present invention and the modifications thereof can be combined with each other without departing from the scope of the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
an element body portion including a plurality of dielectric layers and a plurality of internal electrode layers stacked in a stacking direction, a first main surface and a second main surface opposite to each other in the stacking direction, a first side surface and a second side surface opposite to each other in a width direction orthogonal or substantially orthogonal to the stacking direction, and a first end surface and a second end surface opposite to each other in a length direction orthogonal or substantially orthogonal to the stacking direction and the width direction; and
an external electrode on each of the first end surface and the second end surface and connected to the plurality of internal electrode layers; wherein
in a cross section along the stacking direction and the width direction at a central portion of the element body portion in the length direction, a maximum displacement amount in the width direction in the plurality of internal electrode layers is about 5 μm or less;
opposite edges of each of the plurality of internal electrode layers in the width direction include two straight portions and two curved portions, the two straight portions extending linearly in the length direction while being spaced apart from each other in the width direction, the two curved portions being respectively connected to the two straight portions and curved at a curvature to cause the two curved portions to approach each other in the width direction with an increasing distance from the two straight portions in the length direction;
a connection end located at an end of each of the plurality of internal electrode layers in the length direction and connected to the external electrode is connected to the two curved portions; and
in the first end surface and the second end surface, the maximum displacement amount in the width direction at the connection end in the plurality of internal electrode layers is about 5 μm or less.

2. The multilayer ceramic capacitor according to claim 1, wherein
the element body portion includes a ridge portion at which two adjacent surfaces of the first side surface, the second side surface, the first end surface, and the second end surface intersect each other; and
the curvature of each of the two curved portions is smaller than a curvature of the ridge portion.

3. The multilayer ceramic capacitor according to claim 1, wherein, in the element body portion, a side margin portion located between the first side surface and the plurality of internal electrode layers and a side margin portion located between the second side surface and the plurality of internal electrode layers in the width direction each include a plurality of layers stacked in the width direction.

4. The multilayer ceramic capacitor according to claim 3, wherein
the element body portion includes a ridge portion at which two adjacent surfaces of the first side surface, the second side surface, the first end surface, and the second end surface intersect each other;
an innermost layer located on an innermost side in the width direction among the plurality of layers of each side margin portion extends along the plurality of internal electrode layers; and
a curvature of a surface located on an outer side of the innermost layer in the width direction is greater than the curvature of each of the two curved portions and smaller than a curvature of the ridge portion.

5. The multilayer ceramic capacitor according to claim 1, wherein Mg is segregated at the opposite edges of each of the plurality of internal electrode layers in the width direction.

6. The multilayer ceramic capacitor according to claim 1, wherein
the element body portion includes a plurality of corner portions at which three surfaces of the first and second main surfaces, first and second side surfaces, and first and second end surfaces of the element body portion intersect each other; and
each of the plurality of corner portions are rounded.

7. The multilayer ceramic capacitor according to claim 1, wherein each of the external electrodes covers an entirety or substantially an entirety of the respective first and second end surfaces.

8. The multilayer ceramic capacitor according to claim 1, wherein each of the external electrodes includes a base electrode layer and a plating layer on the base electrode layer.

9. The multilayer ceramic capacitor according to claim 8, wherein the base electrode layer includes a baked layer including glass and metal.

10. The multilayer ceramic capacitor according to claim 9, wherein the metal includes Ni, Cu, Ag, Pd, or Au, or an alloy including at least one of Ni, Cu, Ag, Pd, or Au.

11. The multilayer ceramic capacitor according to claim 8, wherein the base electrode layer includes a resin conductive layer including conductive particles and a thermosetting resin.

12. The multilayer ceramic capacitor according to claim 8, wherein
the base electrode layer includes a thin electrode layer including deposited metal particles; and
a thickness of the thin electrode layer is about 1 μm or less.

13. The multilayer ceramic capacitor according to claim 8, wherein the plating layer includes a metal of Ni, Cu, Ag, Pd, or Au, or an alloy including at least one of Ni, Cu, Ag, Pd, or Au.

14. The multilayer ceramic capacitor according to claim 8, wherein the plating layer includes a first plating layer and a second plating layer on the first plating layer.

15. The multilayer ceramic capacitor according to claim 14, wherein each of the first and second plating layers includes a metal of Cu, Ni, Sn, Pb, Au, Ag, Pd, Bi, or Zn, or an alloy including at least one of Cu, Ni, Sn, Pb, Au, Ag, Pd, Bi, or Zn.

16. The multilayer ceramic capacitor according to claim 1, wherein a thickness of each of the plurality of internal electrode layers is about 0.4 μm or more and about 0.9 μm or less.

17. The multilayer ceramic capacitor according to claim 1, wherein each of the plurality of internal electrode layers includes a metal of Ni, Cu, Ag, Pd, or Au, or an alloy including at least one of Ni, Cu, Ag, Pd, or Au.

18. The multilayer ceramic capacitor according to claim 1, wherein a thickness of each of the plurality of dielectric layers is about 0.5 μm or more and about 0.8 μm or less.

19. The multilayer ceramic capacitor according to claim 1, wherein each of the plurality of dielectric layers includes BaTiO₃, CaTiO₃, SrTiO₃, or CaZrO₃ as a main component.

20. The multilayer ceramic capacitor according to claim 19, wherein each of the plurality of dielectric layers includes a Mn compound, an Fe compound, a Cr compound, a Co compound, or a Ni compound as a secondary component.
